(19) United States
(12) Patent Application Publication
(10) Pub. No.: US 2013/0017751 A1
(43) Pub. Date: Jan. 17, 2013

(54) METHOD FOR PRODUCING PLASMA DISPLAY PANEL

(71) Applicants: Masashi Gotou, Osaka (JP); Takuji Tsujita, Osaka (JP); Hideji Kawarazaki, Osaka (JP); Keiji Horikawa, Osaka (JP); Chiharu Koshio, Osaka (JP); Kanako Okumura, Osaka (JP); Masanori Miura, Osaka (JP)

(72) Inventors: Masashi Gotou, Osaka (JP); Takuji Tsujita, Osaka (JP); Hideji Kawarazaki, Osaka (JP); Keiji Horikawa, Osaka (JP); Chiharu Koshio, Osaka (JP); Kanako Okumura, Osaka (JP); Masanori Miura, Osaka (JP)

(21) Appl. No.: 13/634,169

(22) PCT Filed: Mar. 17, 2011
(86) PCT No.: PCT/JP2011/001570

§ 371 Date: Sep. 11, 2012

(30) Foreign Application Priority Data
Mar. 26, 2010 (JP) 2010-071987
Mar. 26, 2010 (JP) 2010-071988

(51) Int. Cl. H01J 9/385

(52) U.S. Cl. 445/25

(57) ABSTRACT

It is a method for manufacturing a plasma display panel having a discharge space, and a protective layer opposed to the discharge space. A gas containing a reducing organic gas is introduced into the discharge space, and the protective layer is exposed to the reducing organic gas. Then, the reducing organic gas is emitted from the discharge space. Then, a discharge gas is enclosed in the discharge space. The protective layer contains at least a first metal oxide and a second metal oxide. Furthermore, the protective layer has at least one peak in an X-ray diffraction analysis. The peak exists between a first peak of the first metal oxide in the X-ray diffraction analysis, and a second peak of the second metal oxide in the X-ray analysis. The first peak and the second peak show the same surface orientation as a surface orientation shown by the peak.

### TECHNICAL FIELD

A technique disclosed hereinbelow relates to a method for producing a plasma display panel to be used in a display device or the like.

### BACKGROUND ART

A plasma display panel (hereinafter, referred to as a PDP) has a front plate and a rear plate. The front plate has a glass substrate, a display electrode formed on one main surface of the glass substrate, a dielectric layer to cover the display electrode and function as a capacitor, and a protective layer made of magnesium oxide (MgO) formed on the dielectric layer.

In order to increase the number of primary electrons released from the protective layer, for example, an attempt has been made in which silicon (Si) or aluminum (Al) is added to MgO in the protective layer (for example, see Patent Literatures 1, 2, 3, 4, 5, etc.).

### CITATION LIST

### Patent Literature

PTL 1: Unexamined Japanese Patent Publication No. 2002-260535
PTL 2: Unexamined Japanese Patent Publication No. 11-339665
PTL 3: Unexamined Japanese Patent Publication No. 2006-59779
PTL 4: Unexamined Japanese Patent Publication No. 8-236028
PTL 5: Unexamined Japanese Patent Publication No. 10-334809

### SUMMARY OF THE INVENTION

It is a method for producing a plasma display panel having a discharge space and a protective layer that faces the discharge space. By introducing a gas containing a reducing organic gas into the discharge space, the protective layer is exposed to the reducing organic gas. Then, the reducing organic gas is exhausted from the discharge space. Then, a discharge gas is enclosed to the discharge space. The protective layer includes a base film made of magnesium oxide and a plurality of metal oxide particles that are dispersed over the base film. The metal oxide particle includes at least a first metal oxide and a second metal oxide. Moreover, the metal oxide particle has at least one peak in an X-ray diffraction analysis. The peak is located between a first peak in the X-ray diffraction analysis of the first metal oxide and a second peak in the X-ray diffraction analysis of the second metal oxide. The first peak and the second peak have the same plane orientation as the plane orientation indicated by the peak. The first metal oxide and the second metal oxide are two kinds of oxides selected from the group consisting of magnesium oxide, calcium oxide, strontium oxide and barium oxide.

### BRIEF DESCRIPTION OF DRAWINGS

FIG. 1 is a perspective view illustrating a structure of a PDP in accordance with an embodiment.

FIG. 2 is a cross-sectional view illustrating a configuration of a front plate according to an exemplary embodiment.

FIG. 3 is a view showing a production flow of the PDP according to the exemplary embodiment.

FIG. 4 is a view showing an example of a first temperature profile.

FIG. 5 is a view showing an example of a second temperature profile.

FIG. 6 is a view showing an example of a third temperature profile.

FIG. 7 is a view showing results of an X-ray diffraction analysis carried out on the surface of a base film according to the exemplary embodiment.

FIG. 8 is a view showing results of an X-ray diffraction analysis carried out on the surface of another base film according to the exemplary embodiment.

FIG. 9 is an enlarged view of aggregated particles according to the exemplary embodiment.

FIG. 10 is a graph showing a relation between a discharge delay of the PDP and a calcium concentration in the base film.

FIG. 11 is a graph showing an electron emission performance in the PDP and a Vscn lighting voltage.

FIG. 12 is a graph showing a relation between an average particle diameter of the aggregated particles and electron emission performance.

### DESCRIPTION OF EMBODIMENTS

### 1. Structure of PDP 1

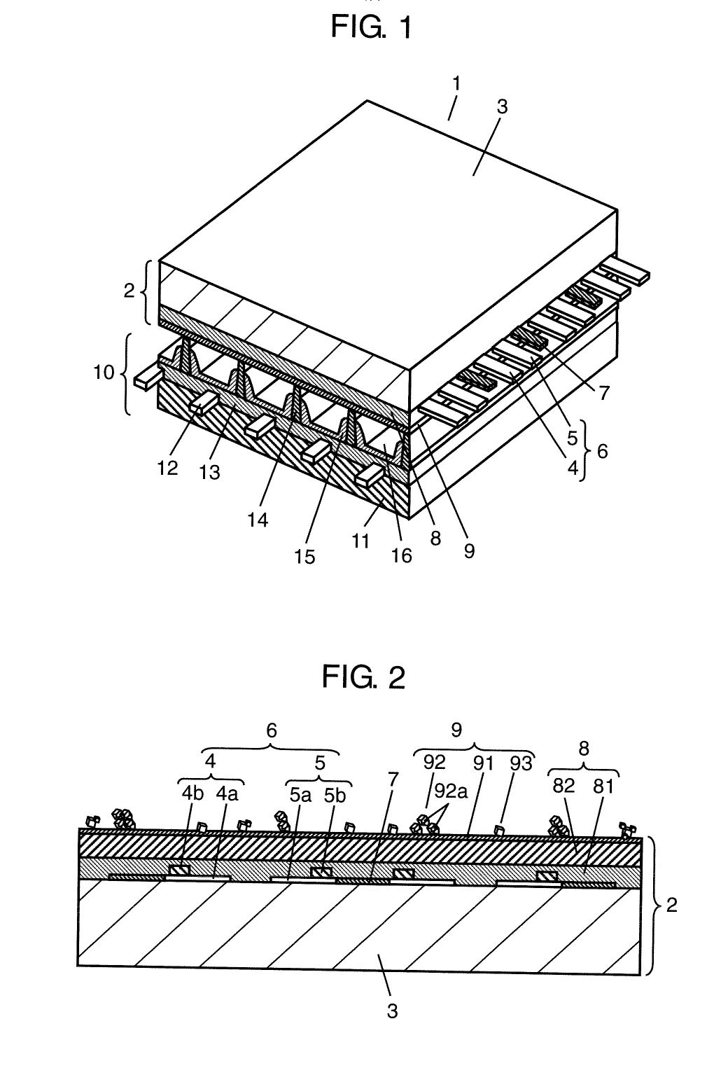

A basic structure of a PDP is a general alternating current surface discharge type PDP. As shown in FIGS. 1 and 2, PDP 1 is provided in such a manner that front plate 2 including front glass substrate 3 and the like and rear plate 10 including rear glass substrate 11 and the like are arranged so as to be opposed to each other. Front plate 2 and rear plate 10 are sealed in an air-tight manner by a sealing material made of glass frit or the like on their peripheral portions. A discharge gas such as neon (Ne) and xenon (Xe) is enclosed at a pressure of 53 kPa (400 Torr) to 80 kPa (600 Torr) in discharge space 16 provided in sealed PDP 1.

On front glass substrate 3, a plurality of rows of paired belt-shaped display electrodes 6, each composed of scan electrode 4 and sustain electrode 5, and black stripes 7 are arranged in parallel with each other. Dielectric layer 8 serving as a capacitor is formed on front glass substrate 3 so as to cover display electrodes 6 and black stripes 7. Moreover, protective layer 9 composed of magnesium oxide (MgO) or the like is formed on a surface of dielectric layer 8. Protective layer 9 will be described later in detail.

Each of scan electrode 4 and sustain electrode 5 has a structure in which a bus electrode composed of Ag is stacked on a transparent electrode composed of a conductive metal oxide such as an indium tin oxide (ITO), a tin oxide (SnO₂), or a zinc oxide (ZnO).

On rear glass substrate 11, a plurality of data electrodes 12 each composed of a conductive material mainly containing silver (Ag) are arranged in parallel with each other in a direction orthogonal to display electrodes 6. Data electrode 12 is covered with insulating layer 13. Moreover, on insulating layer 13 between data electrodes 12, barrier rib 14 having a predetermined height is formed to section discharge space 16. In a groove between barrier ribs 14, phosphor layer 15 emitting red light by ultraviolet rays, phosphor layer 15 emitting green light thereby and phosphor layer 15 emitting blue light thereby are sequentially applied and formed for each of data electrodes 12. A discharge cells is formed at a position in which display electrode 6 and data electrode 12 intersect with each other. The discharge cell having phosphor layers 15 of red, green and blue colors aligned in a direction along discharge electrode 6 serves as a pixel for a color display.

Additionally, in the present exemplary embodiment, the discharge gas enclosed to discharge space 16 contains 10% by volume or more and 30% by volume or less of Xe.

### 2. Method for Producing PDP 1

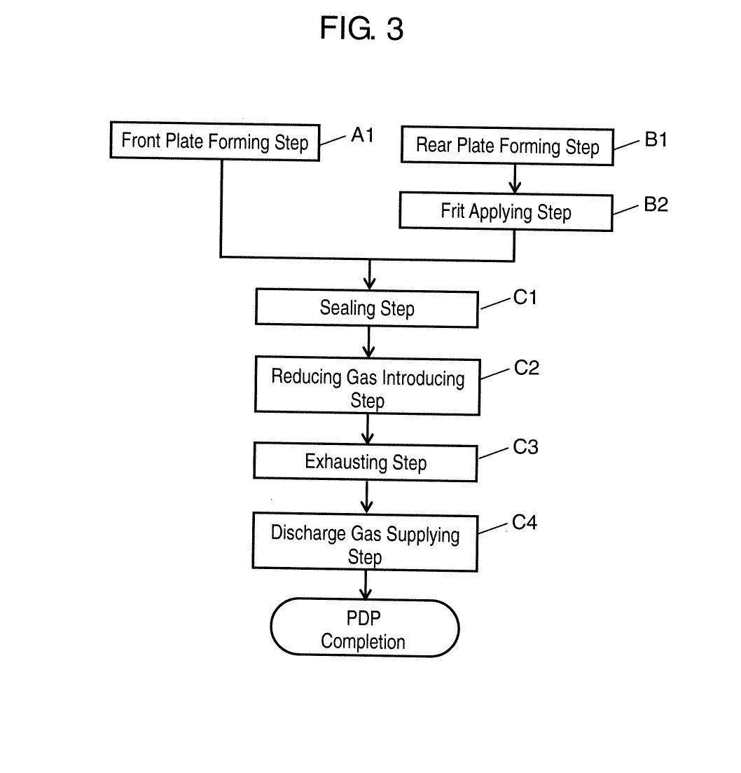

As shown in FIG. 3, the method for producing PDP 1 according to the present exemplary embodiment includes front plate forming step A1, rear plate forming step B1, frit applying step B2, sealing step C1, reducing gas introducing step C2, exhausting step C3 and discharge gas supplying step C4.

### 2-1. Front Plate Forming Step A1

In front plate forming step A1, scan electrode 4, sustain electrode 5 and black stripe 7 are formed on front glass substrate 3 by a photolithography method. Scan electrode 4 and sustain electrode 5 have metal bus electrode 4b and metal bus electrode 5b containing silver (Ag) for ensuring conductivity, respectively. Moreover, scan electrode 4 and sustain electrode 5 have transparent electrode 4a and transparent electrode 5a, respectively. Metal bus electrode 4b is stacked on transparent electrode 4a. Metal bus electrode 5b is stacked on transparent electrode 5a.

As a material for transparent electrodes 4a and 5a, indium tin oxide (ITO) or the like is used so as to ensure transparency and electric conductivity. First, an ITO thin film is formed on front glass substrate 3 by a sputtering method. Then, transparent electrodes 4a and 5a are formed into predetermined patterns by a photolithography method.

As a material for metal bus electrodes 4b and 5b, an electrode paste containing silver (Ag), a glass frit to bind the silver, a photosensitive resin, a solvent, and the like is used. First, the electrode paste is applied onto front glass substrate 3 by a screen printing method or the like. Then, the solvent is removed from the electrode paste in a baking oven. Then, the electrode paste is exposed to light through a photo-mask having a predetermined pattern.

Then, the electrode paste is developed so that a metal bus electrode pattern is formed. Finally, the metal bus electrode pattern is fired at a predetermined temperature in a baking oven. In other words, the photosensitive resin is removed from the metal bus electrode pattern. Moreover, the glass frit in the metal bus electrode pattern is melt. The melt glass frit is again vitrified after the firing step. Through the above-mentioned steps, metal bus electrodes 4b and 5b are formed.

Black stripe 7 is made of a material containing a black pigment. Then, dielectric layer 8 is formed. Then, dielectric layer 8 and protective layer 9 are formed. Dielectric layer 8 and protective layer 9 will be described later in detail.

Through the above-mentioned steps, front plate 2 having predetermined constituent members is completed on rear glass substrate 3.

### 2-2. Rear Plate Forming Step B1

Data electrode 12 is formed on rear glass substrate 11 by a photolithography method. As a material for data electrode 12, a data electrode paste containing silver (Ag) for ensuring conductivity, a glass frit to bind the silver, a photosensitive resin, a solvent, and the like is used. First, the data electrode paste is applied onto rear glass substrate 11 with a predetermined thickness by a screen printing method or the like. Then, the solvent is removed from the data electrode paste in a baking oven. Then, the data electrode paste is exposed to light through a photo-mask having a predetermined pattern. Then, the data electrode paste is developed so that a data electrode pattern is formed. Finally, the data electrode pattern is fired at a predetermined temperature in a baking oven. In other words, the photosensitive resin is removed from the data electrode pattern. Moreover, the glass frit in the data electrode pattern is melt. The melt glass frit is again vitrified after the firing step. Through the above-mentioned steps, data electrode 12 is formed. Here, the data electrode paste may be applied by a sputtering method, a vapor deposition method or the like other than the screen printing method.

Then, insulating layer 13 is formed. As a material for insulating layer 13, an insulating paste containing a dielectric glass frit, a resin, a solvent, and the like is used. First, the insulating paste is applied onto rear glass substrate 11, on which data electrode 12 has been formed, with a predetermined thickness in a manner so as to cover data electrodes 12 by a screen printing method or the like. Then, the solvent is removed from the insulating paste in a baking oven. Finally, the insulating paste is fired at a predetermined temperature in a baking oven. In other words, the resin is removed from the insulating layer. Moreover, the dielectric glass frit is melt. The melt dielectric glass frit is again vitrified after the firing step. Through the above-mentioned steps, insulating layer 13 is formed. Here, the insulating paste may be applied by a die coating method, a spin coating method, or the like other than the screen printing method. Moreover, without using the insulating paste, a film used as insulating layer 13 can be formed by a CVD (Chemical Vapor Deposition) method, or the like.

Then, barrier rib 14 is formed by a photolithography method. As a material for barrier rib 14, a barrier rib paste containing filler, a glass frit to bind the filler, a photosensitive resin, a solvent, and the like is used. First, the barrier rib paste is applied onto insulating layer 13 with a predetermined thickness by a die coating method or the like. Then, the solvent is removed from the barrier rib paste in a baking oven. Then, the barrier rib paste is exposed to light through a photo-mask having a predetermined pattern. Then, the barrier rib paste is developed so that a barrier rib pattern is formed. Finally, the barrier rib pattern is fired at a predetermined temperature in a baking oven. In other words, the photosensitive resin is removed from the barrier rib pattern. Moreover, the glass frit in the barrier rib pattern is melt. The melt glass frit is again vitrified after the firing step. Through the above-mentioned steps, barrier rib 14 is formed. Here, a sand blasting method or the like may be used other than the photolithography method.

Then, phosphor layer 15 is formed. As a material for phosphor layer 15, a phosphor paste containing phosphor particles, a binder, a solvent, and the like is used. First, the phosphor paste is applied onto insulating layer 13 between adjacent barrier ribs 14 as well as a side face of barrier rib 14 with a predetermined thickness by a dispensing method or the like. Then, the solvent is removed from the phosphor paste in a baking oven. Finally, the phosphor paste is fired at a predetermined temperature in a baking oven. In other words, the resin is removed from the phosphor paste. Through the above-mentioned steps, phosphor layer 15 is formed. Here, a screen printing method or the like may be used other than the dispensing method.

Through the above-mentioned steps, rear plate 10 having predetermined constituent members is completed on rear glass substrate 11.

### 2-3. Frit Applying Step B2

A glass frit serving as a sealing member is applied onto the outside of an image display area of rear plate 10 formed in rear plate production step B1. Then, the glass frit is calcined at a temperature of about 350° C. The solvent components and the like are removed by the calcination step.

As the sealing member, frit mainly composed of bismuth oxide or vanadium oxide is desirable. As the frit mainly composed of bismuth oxide, for example, a material, prepared by adding filler made of an oxide such as Al₂O₃, SiO₂ or cordierite to a Bi₂O₃—B₂O₃—RO-MO series (wherein, R represents any of Ba, Sr, Ca and Mg, and M represents any of Cu, Sb and Fe) glass material, may be used. Moreover, as the frit mainly composed of vanadium oxide, for example, a material, prepared by adding filler made of an oxide such as Al₂O₃, SiO₂ or cordierite to a V₂O₅—BaO—TeO—WO series glass material, may be used.

### 2-4. From Sealing Step C1 to Discharge Gas Supplying Step C4

Front plate 2 and rear plate 10 having been subjected to frit coating step B1 are arranged so as to be opposed to each other so that the peripheral portions thereof are sealed with a sealing member. Thereafter, a discharge gas is enclosed to discharge space 16.

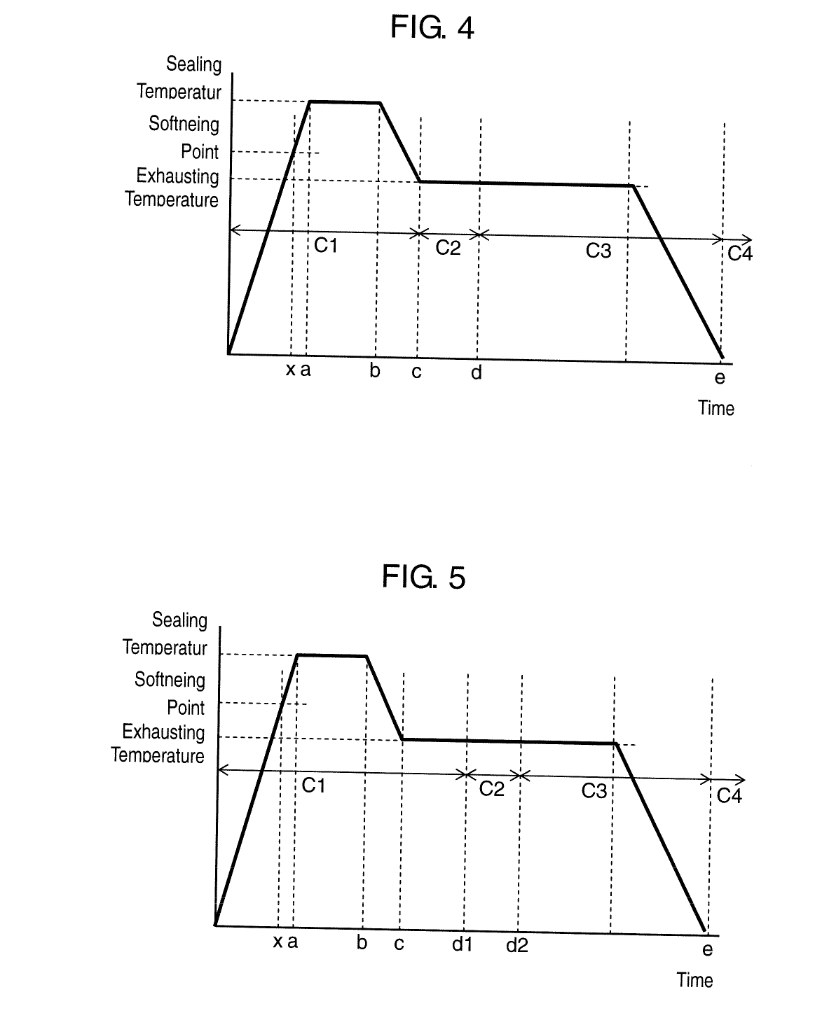

In sealing step C1, reducing gas introducing step C2, exhausting step C3 and discharge gas supplying step C4 according to the present exemplary embodiment, treatments having temperature profiles exemplified in FIGS. 4 to 6 are carried out in the same device.

A sealing temperature indicated in FIGS. 4 to 6 refers to a temperature at which front plate 2 and rear plate 10 are sealed with each other by a frit serving as a sealing material. In the present exemplary embodiment, the sealing temperature is, for example, about 490° C. Moreover, a softening point indicated in FIGS. 4 to 6 refers to a temperature at which a frit serving as a sealing material starts to soften. The softening point in the present exemplary embodiment is, for example, about 430° C. Furthermore, an exhaust temperature indicated in FIGS. 4 to 6 refers to a temperature at which a gas containing a reducing organic gas is exhausted from the discharge space. In the present exemplary embodiment, the exhaust temperature is, for example, about 400° C.

### 2-4-1. First Temperature Profile

As shown in FIG. 4, first, in sealing step C1, the temperature is raised from room temperature to a sealing temperature. Then, during a period of a-b, the temperature is maintained at the sealing temperature. Thereafter, the temperature is lowered from the sealing temperature to an exhaust temperature during a period of b-c. In the period of b-c, the discharge space is exhausted. That is, the discharge space is brought to a reduced pressure state.

Then, in reducing gas introducing step C2, the temperature is maintained at the exhaust temperature during a period of c-d. During the period of c-d, a gas containing a reducing organic gas is introduced into the discharge space. During the period of c-d, protective layer 9 is exposed to the gas containing a reducing organic gas.

Thereafter, in exhausting step C3, the temperature is maintained at the exhaust temperature for a predetermined period of time. Then, the temperature is lowered to room temperature. In a period of d-e, since the discharge space is exhausted, the gas containing a reducing organic gas is exhausted.

Then, in discharge gas supplying step C4, a discharge gas is introduced into the discharge space. That is, during a period from a point e and thereafter, with its temperature dropped to about room temperature, the discharge gas is introduced.

### 2-4-2. Second Temperature Profile

As shown in FIG. 5, first, in sealing step C1, the temperature is raised from room temperature to a sealing temperature. Then, during a period of a-b, the temperature is maintained at the sealing temperature. Thereafter, the temperature is lowered from the sealing temperature to an exhaust temperature during a period of b-c. During a period of c-d1 at which the temperature is maintained at the exhaust temperature, the discharge space is exhausted. That is, the discharge space is brought to a reduced pressure state.

Then, in reducing gas introducing step C2, the temperature is maintained at the exhaust temperature during a period of d1-d2. During the period of d1-d2, a gas containing a reducing organic gas is introduced into the discharge space. During the period of d1-d2, protective layer 9 is exposed to the gas containing a reducing organic gas.

Thereafter, in exhausting step C3, the temperature is maintained at the exhaust temperature for a predetermined period of time. Then, the temperature is lowered to room temperature. In a period of d2-e, since the discharge space is exhausted, the gas containing a reducing organic gas is exhausted.

Then, in discharge gas supplying step C4, a discharge gas is introduced into the discharge space. That is, during a period from a point e and thereafter, with its temperature dropped to about room temperature, the discharge gas is introduced.

### 2-4-3. Third Temperature Profile

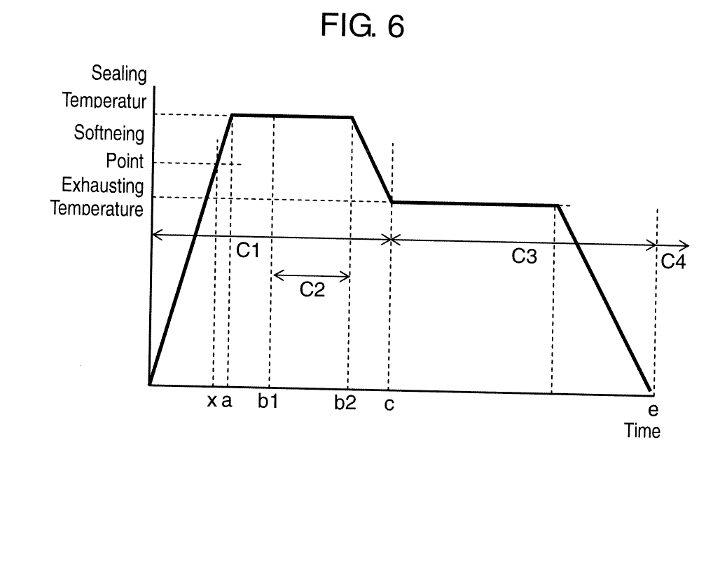

As shown in FIG. 6, first, in sealing step C1, the temperature is raised from room temperature to a sealing temperature. Then, during a period of a-b1-b2, the temperature is maintained at the sealing temperature. Then, during a period of a-b1, the discharge space is exhausted. That is, the discharge space is brought to a reduced pressure state. Thereafter, the temperature is lowered from the sealing temperature to an exhaust temperature during a period of b2-c.

Reducing gas introducing step C2 is carried out within the period of sealing step C1. The temperature is maintained at the sealing temperature during a period of b1-b2. Thereafter, within a period of b2-c, the temperature is lowered to the exhaust temperature. During the period of b1-c, a gas containing a reducing organic gas is introduced into the discharge space. During the period of b1-c, protective layer 9 is exposed to the gas containing a reducing organic gas.

Thereafter, in exhausting step C3, the temperature is maintained at the exhaust temperature for a predetermined period of time. Then, the temperature is lowered to room temperature. In a period of c-e, since the discharge space is exhausted, the gas containing a reducing organic gas is exhausted.

Then, in discharge gas supplying step C4, a discharge gas is introduced into the discharge space. That is, during a period from a point e and thereafter, with its temperature dropped to about room temperature, the discharge gas is introduced.

Additionally, in any of the temperature profiles, approximately the same function is exerted.

### 2-4-4. Detailed Description of Reducing Organic Gas

As shown in Table 1, a CH-based organic gas having a molecular weight of 58 or less, with a high reducing function, is desirably used as the reducing organic gas. By mixing at least one gas selected from various reducing organic gases with a rare gas, nitrogen gas, or the like, a gas containing an organic gas is produced.

TABLE 1

| | | | Molecular | Vapor | Boiling | Easiness in | Reducing |
|---|---|---|---|---|---|---|---|
| Organic gas | C | H | weight | pressure | point | decomposition | function |
| Acetylene | 2 | 2 | 26 | A | A | A | A |
| Ethylene | 2 | 4 | 28 | A | A | A | A |
| Ethane | 2 | 6 | 30 | A | A | B | A |
| Methylacetylene | 3 | 4 | 40 | A | A | A | A |
| Propadiene | 3 | 4 | 40 | A | A | A | A |
| Propylene | 3 | 6 | 42 | A | A | A | A |
| Cyclopropane | 3 | 6 | 42 | A | A | A | A |
| Propane | 3 | 8 | 44 | A | A | B | A |
| 1-Butyne | 4 | 6 | 54 | C | C | A | A |
| 1,2-Butadiene | 4 | 6 | 54 | A | C | A | A |
| 1,3-Butadiene | 4 | 6 | 54 | A | A | A | A |
| Ethylacetylene | 4 | 6 | 54 | C | C | A | A |
| 1-Butene | 4 | 8 | 56 | A | A | A | A |
| Butane | 4 | 10 | 58 | A | A | B | A |

In Table 1, column C represents the number of carbon atoms contained in one molecule of an organic gas. Column H represents the number of hydrogen atoms contained in one molecule of the organic gas.

As shown in Table 1, in the column of vapor pressure, each gas having a vapor pressure of 100 kPa or higher at 0° C. is denoted as “A”. Moreover, each gas having a vapor pressure lower than 100 kPa at 0° C. is denoted as “C”. In the column of boiling point, each gas having a boiling point of 0° C. or lower at 1 atmospheric pressure is denoted as “A”. Moreover, each gas having a boiling point higher than 0° C. at 1 atmospheric pressure is denoted as “C”. In the column of easiness in decomposition, each gas that is easily decomposed is denoted as “A”. Each gas that is normally decomposed is denoted as “B”. In the column of reducing function, each gas having a sufficient reducing function is denoted as “A”.

In Table 1, “A” means a good characteristic. “B” means a normal characteristic. “C” means an insufficient characteristic.

From the viewpoint of easiness in handling of an organic gas in the PDP production step, a reducing organic gas that can be charged into a gas cylinder and supplied is desirable. Moreover, from the viewpoint of easiness in handling during the PDP production step, a reducing organic gas having a vapor pressure of 100 kPa or higher at 0° C., or a reducing organic gas having a boiling point of 0° C. or lower, or a reducing organic gas having a small molecular weight is desirable.

There is a possibility that one portion of the gas containing a reducing organic gas still remains in the discharge space after exhausting step C3. Therefore, the reducing organic gas is desirably provided with an easily decomposable characteristic.

By taking into consideration the easiness in handling during the production step and the easily decomposable characteristic, the reducing organic gas is desirably a hydrocarbon-based gas without containing oxygen selected from acetylene, ethylene, methylacetylene, propadiene, propylene and cyclopropane. At least one kind of gas selected from these reducing organic gases can be mixed with a rare gas or nitrogen gas to be used.

The mixing ratio of the rare gas or nitrogen gas and the reducing organic gas is determined in its lower limit in accordance with the combustion rate of the reducing organic gas to be used. Its upper limit is about several % by volume. When the mixing ratio of the reducing organic gas is too high, organic components are polymerized, and tend to form polymers. In this case, the polymers remain in the discharge space to cause influences on the characteristics of the PDP. Therefore, it is preferable to appropriately adjust the mixing ratio depending on the components of the reducing organic gas to be used.

MgO, CaO, SrO, BaO and the like are highly reactive with impurity gases such as water, carbon dioxide, hydrocarbon, and the like. In particular, when these react with water or carbon dioxide, the discharging characteristic tends to deteriorate to cause deviations in discharging characteristic in each discharge cell.

Therefore, in sealing step C1, it is preferable to allow an inert gas to flow through a through-hole that is opened to discharge space 16 so as to bring the inside of discharge space 16 into a positive pressure state, and the sealing step is then carried out. This makes it possible to suppress a reaction between base film 91 and the impurity gases. As the inert gas, for example, nitrogen, helium, neon, argon, xenon, or the like may be used.

In addition, dry air (dry gas) may be supplied instead of the inert gas. In this case, it can at least prevent water from reacting, and also can reduce a production cost compared with the inert gas.

More specifically, in sealing step C1 shown in FIGS. 4 to 6, a nitrogen gas may be supplied at a flow rate of 2 L/min until time x at which the temperature reaches the softening point. Discharge space 16 is kept at the positive pressure due to the nitrogen gas. When the temperature exceeds the softening point, the supply of the nitrogen gas is stopped. Discharge space 16 is kept at the positive pressure by the nitrogen gas. The temperature is kept at the sealing temperature for the period of a-b. Discharge space 16 is filled with the nitrogen gas. Then, the temperature drops from the sealing temperature to the exhausting temperature for the period of b-c. The nitrogen gas in the discharge space 16 is emitted for the period of b-c. That is, the discharge space is put into the reduced-pressure state. A description for the following period is the same as the above description.

### 3. Detail of Dielectric Layer 8

As shown in FIG. 2, dielectric layer 8 in this exemplary embodiment has at least two layers such as first dielectric layer 81 to cover display electrode 6 and black stripe 7, and second dielectric layer 82 to cover first dielectric layer 81.

### [3-1. First Dielectric Layer 81]

A dielectric material of first dielectric layer 81 contains 20% to 40% by weight of dibismuth trioxide (Bi₂O₃). In addition, the dielectric material of first dielectric layer 81 contains 0.5% to 12% by weight of at least one kind selected from a group including a calcium oxide (CaO), strontium oxide (SrO), and barium oxide (BaO). Furthermore, the dielectric material of first dielectric layer 81 contains 0.1% to 7% by weight of at least one kind selected from a group including a molybdenum trioxide (MoO₃), tungsten trioxide (WO₃), cerium dioxide (CeO₂), manganese dioxide (MnO₂), copper oxide (CuO), dichrome trioxide (Cr₂O₃), dicobalt trioxide (CO₂O₃), divanadium heptoxide (V₂O₇), and diantimony trioxide (Sb₂O₃).

In addition, other than the above components, it may contain 0% to 40% by weight of zinc oxide (ZnO), 0% to 35% by weight of diboron trioxide (B₂O₃), 0% to 15% by weight of silicon dioxide (SiO₂), and 0% to 10% by weight of dialuminum trioxide (Al₂O₃), so that it may contain a material composition which does not contain a lead component. In addition, there is no specific limitation to a content of the above material composition.

The dielectric material composed of the above composition components is ground by a wet jet mill or a ball mill so that an average particle diameter becomes 0.5 μm to 2.5 μm. The ground dielectric material is dielectric material powder. Then, 55% to 70% by weight of the dielectric material powder and 30% to 45% by weight of a binder component are kneaded well by a three-roller mill, whereby a first dielectric layer paste for die coating or for printing is completed.

The binder component includes ethylcellulose, terpineol containing 1% to 20% by weight of acrylic resin, or butyl carbitol acetate. In addition, the paste may contain dioctyl phthalate, dibutyl phthalate, triphenyl phosphate, and tributyl phosphate as a plasticizer when needed. In addition, as a disperser, it may contain glycerol monooleate, sorbitan sesquioleate, Homogenol (made by Kao corporation), ester phosphate of alkylaryl group. When the disperser is added, printing performance is improved.

The first dielectric layer paste is printed on front glass substrate 3 by the die coating method or the screen printing method so as to cover display electrode 6. The printed first dielectric layer paste is fired after a drying step. A firing temperature is 575° C. to 590° C. which is a little higher than the softening point of the dielectric material.

### 3-2. Second Dielectric Layer 82

A dielectric material of second dielectric layer 82 contains 11% to 20% by weight of Bi₂O₃. In addition, the dielectric material of second dielectric layer 82 contains 1.6% to 21% by weight of at least one kind selected from a group including CaO, SrO, and BaO. Furthermore, the dielectric material of second dielectric layer 82 contains 0.1% to 7% by weight of at least one kind selected from a group including MoO₃, WO₃, cerium dioxide (CeO₂), CuO, Cr₂O₃, Co₂O₃, V₂O₇, Sb₂O₃, and MnO₂.

In addition, other than the above components, it may contain 0% to 40% by weight of ZnO, 0% to 35% by weight of B₂O₃, 0% to 15% by weight of SiO₂, and 0% to 10% by weight of Al₂O₃, so that it may contain a material composition which does not contain a lead component. In addition, there is no specific limitation to a content of the above material composition.

The dielectric material composed of the above composition components is ground by the wet jet mill or the ball mill so that an average particle diameter becomes 0.5 μm to 2.5 μm. The ground dielectric material is dielectric material powder. Then, 55% to 70% by weight of the dielectric material powder and 30% to 45% by weight of a binder component are kneaded well by the three-roller mill, whereby a second dielectric layer paste for die coating or for printing is completed.

The binder component for the second dielectric layer paste is the same as the binder component for the first dielectric layer paste.

The second dielectric layer paste is printed on first dielectric layer 81 by the die coating method or the screen printing method. The printed second dielectric paste is fired after a drying step. A firing temperature is 550° C. to 590° C. which is a little higher than the softening point of the dielectric material.

### 3-3. Film Thickness of Dielectric Layer 8

A film thickness of dielectric 8 is preferably 41 μm or less, including those of first dielectric layer 81 and second dielectric layer 82 in order to ensure visible light transmittance. A content of Bi₂O₃ in first dielectric layer 81 is higher than a content of Bi₂O₃ in second dielectric layer 82 in order to prevent a reaction with Ag contained in metallic bus electrodes 4b and 5b. Thus, visible light transmittance of first dielectric layer 81 is lower than visible light transmittance of second dielectric layer 82. Therefore, a film thickness of first dielectric layer 81 is preferably smaller than a film thickness of second dielectric layer 82.

In addition, when second dielectric layer 82 contains 11% or less by weight of Bi₂O₃, coloring is not likely to be generated. However, bubbles are likely to be generated in second dielectric layer 82. In addition, the content of Bi₂O₃ exceeds 40% by weight, the coloring is likely to be generated, and there is a reduction in transmittance. Therefore, the content of Bi₂O₃ is preferably more than 11% by weight and equal to or less than 40% by weight.

In addition, as the film thickness of dielectric 8 decreases, an effect of brightness improvement and an effect of discharge voltage reduction are improved. Thus, the film thickness is preferably set at a small value to the extent that a withstand voltage does not reduce. Therefore, according to this exemplary embodiment, the film thickness of dielectric layer 8 is 41 μm or less. Furthermore, the film thickness of first dielectric layer 81 is 5 μm to 15 μm. The film thickness of second dielectric layer 82 is 20 μm to 36 μm.

According to PDP 1 in this exemplary embodiment, a coloring phenomenon (yellowing) of front glass substrate 3 is not likely to be generated even when Ag is used in display electrode 6. In addition, bubbles are not likely to be generated in dielectric layer 8, so that dielectric layer 8 provides excellent withstand voltage performance.

3-4. Study about Reason why Yellowing and Bubbles are Prevented from Being Generated

By adding MoO₃ or WO₃ to the dielectric material containing Bi₂O₃, a compound such as Ag₂MoO₄, Ag₂Mo₂O₇, Ag₂Mo₄O₁₃, Ag₂WO₄, Ag₂W₂O₇, and Ag₂W₄O₁₃ are likely to be generated at 580° C. or less. According to this exemplary embodiment, since the firing temperature of dielectric layer 8 is 550° C. to 590° C., silver ions (Ag⁺) diffused in dielectric layer 8 during the firing treatment react with MoO₃ or WO₃ in dielectric layer 8, and generate a stable compound and are stabilized. That is, Ag⁺ is stabilized without being reduced. When Ag⁺ is stabilized, generation of oxygen caused by colloidal Ag can be suppressed. Therefore, the bubbles are prevented from being generated in dielectric 8.

In order to provide the above effect more effectively, it is preferable to set the content of at least one kind selected from MoO₃, WO₃, CeO₂, CuO, Cr₂O₃, CO₂O₃, V₂O₇, Sb₂O₃, and MnO₂ at 0.1% or more by weight, in the dielectric material containing Bi₂O₃. Furthermore, it is further preferable to set it at 0.1% to 7% by weight. Especially, when it is set at less than 0.1% by weight, the yellowing is not prevented from being generated. When it is set at more than 7% by weight, the glass is colored, which is not preferable.

That is, according to dielectric layer 8 in this exemplary embodiment, first dielectric layer 81 which is in contact with metallic bus electrodes 4b and 5b containing Ag prevents the yellowing phenomenon and bubbles from being generated. Furthermore, second dielectric layer 82 provided on first dielectric layer 81 implements high light transmittance. As a result, dielectric layer 8 can prevent the bubbles and yellowing from being generated, and implement the high transmittance as a whole, in PDP 1.

### 4. Detail of Protective Layer 9

Protective layer 9 is required to have a function to retain electric charges to be discharged, and a function to emit secondary electrons at the time of sustained discharge. When the electric charge retention performance is improved, there is a reduction in applied voltage. When the number of the emitted secondary electrons increases, there is a reduction in sustained discharge voltage.

### 4-1. Base Film 91

Protective layer 9 in this exemplary embodiment includes base film 91 and aggregated particles 92. Base film 91 contains at least a first metal oxide and a second metal oxide. The first metal oxide and the second metal oxide are two kinds selected from a group including MgO, CaO, SrO, and BaO. Furthermore, base film 91 has at least one peak in an X-ray diffraction analysis. This peak exists between a first peak of the first metal oxide in the X-ray diffraction analysis and a second peak of the second metal oxide in the X-ray diffraction analysis. The first peak and the second peak show the same surface orientation as a surface orientation of the peak of base film 91.

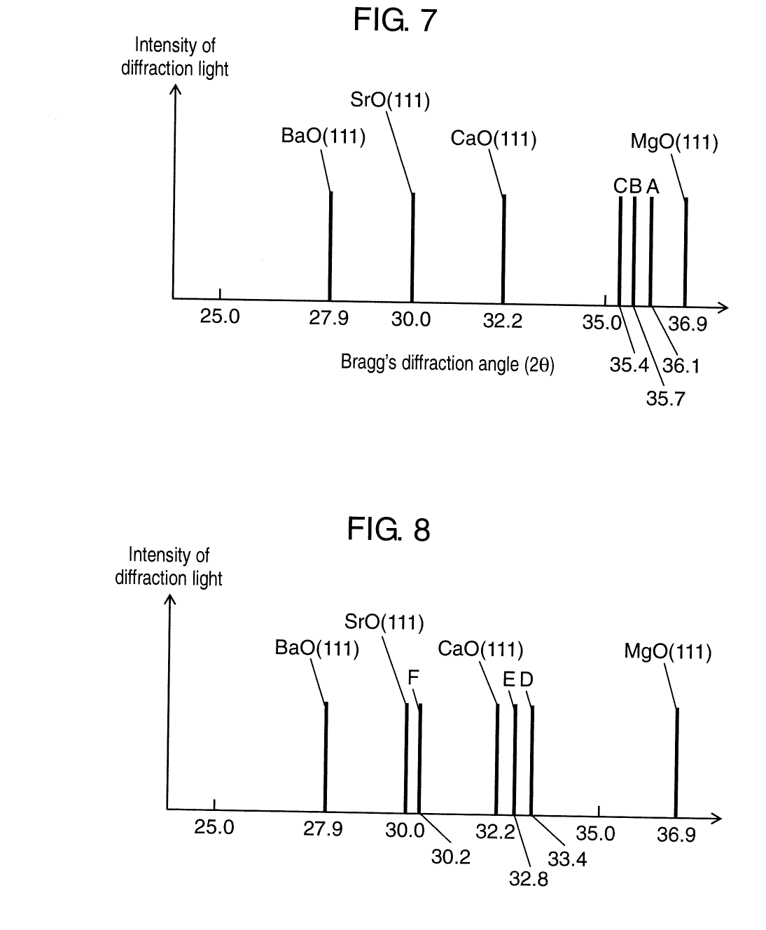

In FIG. 7, a lateral axis shows Bragg's diffraction angle (2θ). A longitudinal axis shows intensity of an X-ray diffraction wave. A unit of the diffraction angle is shown by a degree of 360 degrees which makes one circle. The intensity of the diffraction light is shown by an arbitrary unit. The surface orientation is shown in parenthesis.

As shown in FIG. 7, surface orientation (111) of CaO alone shows a peak at a diffraction angle of 32.2 degrees. Surface orientation (111) of MgO alone shows a peak at a diffraction angle of 36.9 degrees. Surface orientation (111) of SrO alone shows a peak at a diffraction angle of 30.0 degrees. Surface orientation (111) of BaO alone shows a peak at a diffraction angle of 27.9 degrees.

Base film 91 in this exemplary embodiment contains at least two metal oxides selected from a group including MgO, CaO, SrO, and BaO.

As shown in FIG. 7, point A is a peak of surface orientation (111) of base film 91 formed of two materials of MgO and CaO. Point B is a peak of surface orientation (111) of base film 91 formed of two materials of MgO and SrO. Point C is a peak of surface orientation (111) of base film 91 formed of two materials of MgO and BaO.

As shown in FIG. 7, a diffraction angle of point A is 36.1 degrees. Point A exists between the peak of surface orientation (111) of MgO alone as the first metal oxide, and the peak of surface orientation (111) of CaO alone as the second metal oxide.

A diffraction angle of point B is 35.7 degrees. Point B exists between the peak of surface orientation (111) of MgO alone as the first metal oxide, and the peak of surface orientation (111) of SrO alone as the second metal oxide.

A diffraction angle of point C is 35.4 degrees. Point C exists between the peak of surface orientation (111) of MgO alone as the first metal oxide, and the peak of surface orientation (111) of BaO alone as the second metal oxide.

As shown in FIG. 8, point D is a peak of surface orientation (111) of base film 91 formed of three materials of MgO, CaO, and SrO. Point E is a peak of surface orientation (111) of base film 91 formed of three materials of MgO, CaO and BaO. Point F is a peak of surface orientation (111) of base film 91 formed of three materials of BaO, CaO, and SrO.

As shown in FIG. 8, a diffraction angle of point D is 33.4 degrees. Point D exists between the peak of surface orientation (111) of MgO alone as the first metal oxide, and the peak of surface orientation (111) of CaO alone as the second metal oxide.

A diffraction angle of point E is 32.8 degrees. Point E exists between the peak of surface orientation (111) of MgO alone as the first metal oxide, and the peak of surface orientation (111) of SrO alone as the second metal oxide.

A diffraction angle of point F is 30.2 degrees. Point F exists between the peak of surface orientation (111) of MgO alone as the first metal oxide, and the peak of surface orientation (111) of BaO alone as the second metal oxide.

In addition, surface orientation (111) is illustrated in this exemplary embodiment. However, the same is true in another surface orientation.

Depths of CaO, SrO, and BaO from a vacuum level are provided in a shallow region compared with that of MgO. Therefore, when the PDP is driven, it is thought that the number of electrons emitted from energy levels of CaO, SrO, and BaO to a ground state of Xe ion by the Auger effect is greater than the number of electrons emitted from an energy level of MgO thereto.

In addition, as described above, the peak of base film 91 in the X-ray diffraction analysis exists between the peak of the first metal oxide and the peak of the second metal oxide. That is, it is thought that an energy level of base film 91 exists between those of the metal oxides, and the number of electrons emitted by the Auger effect is greater than that of the electrons moved from the energy level of MgO.

As a result, base film 91 in this exemplary embodiment provides preferable second electron emission characteristics compared with the case of MgO alone. As a result, there is a reduction in sustained voltage. Especially, when a partial pressure of Xe serving as the discharge gas is raised to enhance the brightness, there is a reduction in discharge voltage. That is, high-brightness PDP 1 can be provided at low voltage.

### 4-2. Aggregated Particles 92

Aggregated particle 92 is composed of aggregated crystal particles 92a of MgO serving as the metal oxide. It is preferable that aggregated particles 92 are uniformly dispersed over a whole surface of base film 91. Thus, there is a reduction in variation of discharge voltage in PDP 1.

In addition, MgO crystal particles 92a can be produced by a gas-phase synthesis method or a precursor firing method. According to the gas-phase synthesis method, a metal magnesium material with a purity of 99.9% or more is heated under an atmosphere filled with an inert gas. Then, a small amount of oxygen is introduced into the atmosphere, whereby the metal magnesium is directly oxidized. Thus, MgO crystal particles 92a are produced.

According to the precursor firing method, a precursor of MgO is uniformly fired at a high temperature of 700° C. or more. Then, it is slowly cooled down, whereby MgO crystal particles 92a are produced. The precursor includes one or more compounds selected from magnesium alkoxide (Mg(OR)₂), magnesium acetylacetone (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂), and magnesium oxalate (MgC₂O₄). In addition, the selected compound may take a form of a hydrate in a normal state. As the precursor, the hydrate may be used. The compound serving as the precursor is adjusted such that the purity of magnesium oxide (MgO) obtained after fired becomes 99.95% or more preferably becomes 99.98% or more. When an impurity element such as several kinds of alkali metals, B, Si, Fe, or Al is mixed in the compound serving as the precursor, unnecessary particle adhesion or sintering is generated at the time of the heat treatment. As a result, high-crystallinity MgO crystal particles are not likely to be obtained. Thus, it is preferable that an impurity element is removed from the compound when the precursor is previously adjusted.

Then, MgO crystal particles 92a obtained by either of the above methods are dispersed in a solvent, whereby a dispersion liquid is produced. Then, the dispersion liquid is applied to a surface of base film 91 by a spraying method, the screen printing method, or an electrostatic coating method. Then, the solvent is removed through drying and firing steps. Through the above steps, MgO crystal particles 92a are fixed on the surface of base film 91.

### 4-2-1. Detail of Aggregated Particles 92

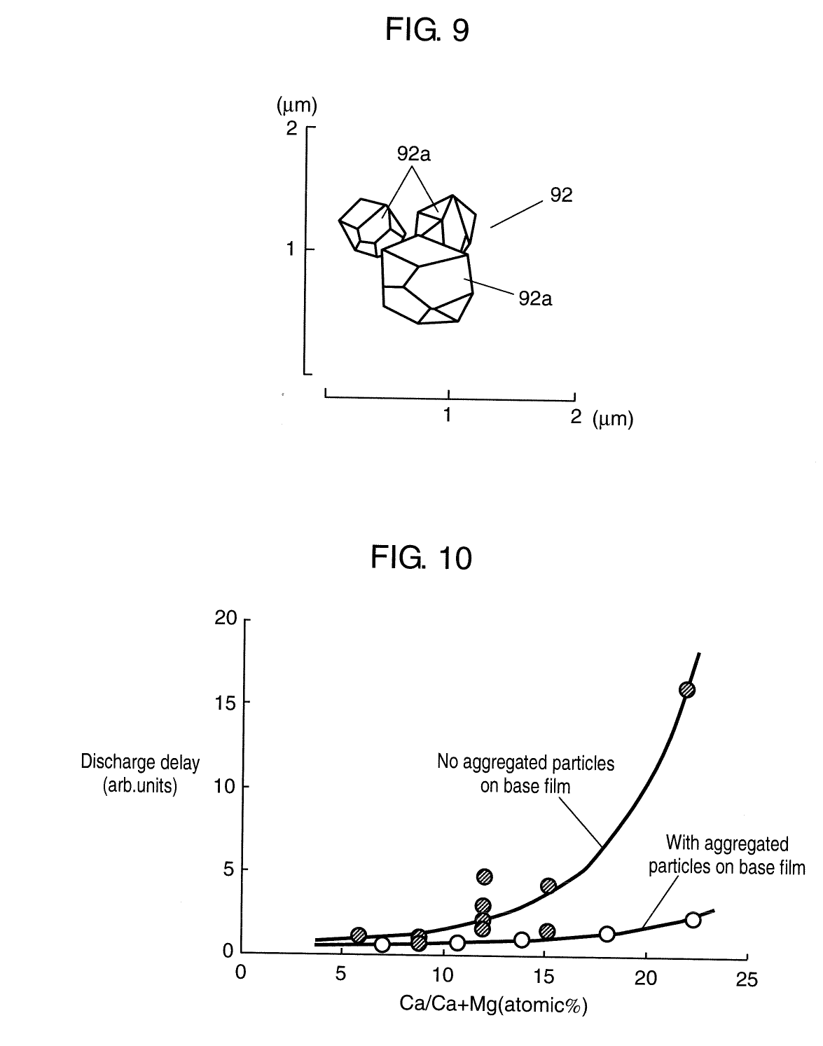

Aggregated particle 92 is provided such that crystal particles 92a each having a predetermined primary particle diameter are put into an aggregated or necked state. That is, the plurality primary particles are not bonded with strong bonding force as a solid, but formed into an aggregated body by static electricity or van der Waals' force, so that they are bonded to the extent that they partially or wholly become the state of the primary particles by external stimulus such as an ultrasonic wave. As shown in FIG. 9, a particle diameter of aggregated particle 92 is about 1 μm, and crystal particle 92a preferably has a polyhedral shape having seven or more faces such as a tetradecahedron or dodecahedron.

In addition, a particle diameter of the primary particle of crystal particle 92a can be controlled by a condition of formation of the crystal particles 92a. For example, when it is produced by firing the precursor of magnesium chloride or magnesium hydroxide, the particle diameter can be controlled by controlling a firing temperature or a firing atmosphere. In general, the firing temperature can be selected within a range of 700° C. to 1500° C. The particle diameter can be controlled to be 0.3 to 2 μm by setting the firing temperature at a relatively high temperature of 1000° C. or more. Furthermore, by heating the precursor, the plurality of primary particles are aggregated or necked in a formation process, whereby aggregated particle 92 can be provided.

Studies by the inventors of the present invention have confirmed that aggregated particles 92 each composed of the plurality of MgO crystal particles mainly have an effect of preventing “discharge delay” in an address discharge, and an effect of improving a temperature dependency of the “discharge delay”. Aggregated particles 92 are superior in initial electron emission characteristics compared with base film 91. Therefore, according to this exemplary embodiment, aggregated particles 92 are arranged as initial electron supply parts required for a discharge pulse rise time.

It is considered that the “discharge delay” is mainly caused due to a deficiency in amount of initial electrons serving as a trigger to be emitted from the surface of base film 91 to discharge space 16. Thus, in order to contribute stable supply of the initial electrons to discharge space 16, aggregated particles 92 are arranged in a dispersed manner on the surface of base film 91. Thus, there are sufficient electrons in discharge space 16 at the time of the rise of the discharge pulse, so that the discharge delay is eliminated. Therefore, due to the above initial electron emission characteristics, even high-definition PDP 1 can be driven at high speed with preferable discharge responsiveness. In addition, the configuration of aggregated particles 92 of the metal oxide arranged on the surface of base film 91 can achieve the effect of improving the temperature dependency of the “discharge delay”, in addition to the main effect of eliminating the “discharge delay” at the time of address discharge.

### 5. Evaluation

### 5-1. Evaluation 1

A plurality of PDPs including base films having different configurations are produced. A mixture gas of Xe and Ne (Xe 15%) is enclosed at 60 kPa in the PDP. Sample A is composed of MgO and CaO. Sample B is composed of MgO and SrO. Sample C is composed of MgO and BaO. Sample D is composed of MgO, CaO, and SrO. Sample E is composed of MgO, CaO, and BaO. In addition, a comparison example is composed of MgO alone.

The sustain voltage is measured for samples A to E. Sample A is 90, sample B is 87, sample C is 85, sample D is 81, and sample E is 82 when assuming that the comparison example is 100. As for samples A to E, the PDP is manufactured by a normal manufacturing method. That is, as for samples A to E, the PDP is manufactured by the manufacturing method which does not have the reducing organic gas introducing step.

When the partial pressure of Xe of the discharge gas is increased from 10% to 15%, the brightness becomes high by about 30% or more, but in the comparison example, the sustain voltage increases by about 10%.

Meanwhile, the sustain voltages of sample A, sample B, sample C, sample D, and sample E are all lower than that of the comparison example by about 10% to 20%.

Then, PDPs 1 including base films 91 having the same configurations of samples A to E are produced by the manufacturing method in this exemplary embodiment. The first temperature profile is used in the period from sealing step C1 to discharge gas supplying step C4.

As the reducing organic gas, propylene, cyclopropane, acetylene, or ethylene is used, as one example. The sustain voltage of PDP 1 in this exemplary embodiment is further lower than those of samples A to E by about 5%.

Furthermore, in a case where before the reducing organic gas is introduced, the nitrogen gas is supplied as the inert gas via the through hole provided in discharge space 16 to put discharge space 16 into the positive pressure state, and then sealing is performed in sealing step C1, it is further lower than those of samples A to E by 5% to 7%.

### 5-2. Evaluation 2

PDPs including protective layers having different configurations are experimentally produced. Configurations include a case where base film 91 is only provided and a case where aggregated particles 92 are arranged on base film 91, as shown in FIG. 10. Base film 91 is formed of MgO and CaO. That is, it corresponds to above-described sample A. In the case where base film 91 is only provided, a Ca concentration increases, and the discharge is further delayed. Meanwhile, in the case where aggregated particles 92 are arranged on base film 91, the discharge delay becomes considerably small. That is, even when the Ca concentration increases, the discharge delay hardly increases. In addition, the discharge delay is measured by a method disclosed in Unexamined Japanese Patent Publication No. 2007-48733. The measurement method will be described later.

### 5-3. Evaluation 3

PDPs including protective layers having different configurations are experimentally produced.

Sample 1 is a PDP only having a protective layer of MgO.

Sample 2 is a PDP only having a protective layer of MgO doped with an impurity such as Al or Si.

Sample 3 is a PDP in which only primary particles of crystal particles 92a of MgO are dispersed on the base film of MgO.

Sample 4 has protective layer 9 corresponding to that of above-described sample A. That is, protective layer 9 has base film 91 composed of MgO and CaO, and aggregated particles 92 uniformly arranged in the dispersed manner on the whole surface of base film 91. In addition, as for base film 91, a diffraction angle showing the peak of surface (111) is 36.1 degrees in the X-ray diffraction analysis.

In addition, samples 1 to 4 are manufactured by the above manufacturing method. Especially, in introducing and emitting the reducing organic gas, the first temperature profile is used. Therefore, samples 1 to 4 differ only in structure of protective layer 9.

As for samples 1 to 4, the electron emission performance and the electric charge retention performance are measured.

In addition, the electron emission performance is a numeric value which increases as an electron emission amount increases. The electron emission performance is expressed as an initial electron emission amount determined by a surface state of the discharge, and a gas kind and its state. The initial electron emission amount can be measured by a method in which a surface is irradiated with ions or an electron beam and an electron current amount emitted from the surface is measured. However, it is difficult to measure it in a non-destructive manner. Thus, the method disclosed in the Unexamined Japanese Patent Publication No. 2007-48733 is used. That is, it is found by measuring a numeric value which gives an indication of discharge-ability, called a statistical time delay of the delay time of the discharge. A numeric value provided by integrating an inverse of the statistical time delay linearly corresponds to the initial electron emission amount. The delay time of the discharge means a time from the rise of the address discharge pulse to the address discharge generated late. It is considered that the discharge delay is mainly caused because the initial electrons serving as the trigger in generating the address discharge are not sufficiently emitted from the protective layer surface to the discharge space.

As an index of the electric charge retention performance, a voltage value applied to the scan electrode to suppress the electric charge emission phenomenon of the PDP (hereinafter, referred to as a Vscn lighting voltage) is used. That is, the fact that the Vscn lighting voltage is low shows that an electric charge retention ability is high. When the Vscn lighting voltage is low, the PDP can be driven at a low voltage. Thus, a part which is small in withstand voltage and capacity can be used as a power supply or an electric part. In a present product, an element having a withstand voltage of 150 V is used for a semiconductor switching element such as an MOSFET to sequentially apply the scan voltage to the panel. The Vscn lighting voltage is preferably suppressed to 120 V or less in view of a fluctuation due to the temperature.

In general, the electron emission ability contradicts the electric charge retention ability in the protective layer. By changing a film formation condition of the protective layer, or doping an impurity such as Al, Si or Ba into the protective layer at the time of film formation, the electron emission performance can be improved. However, as a side effect, the Vscn lighting voltage also increases.

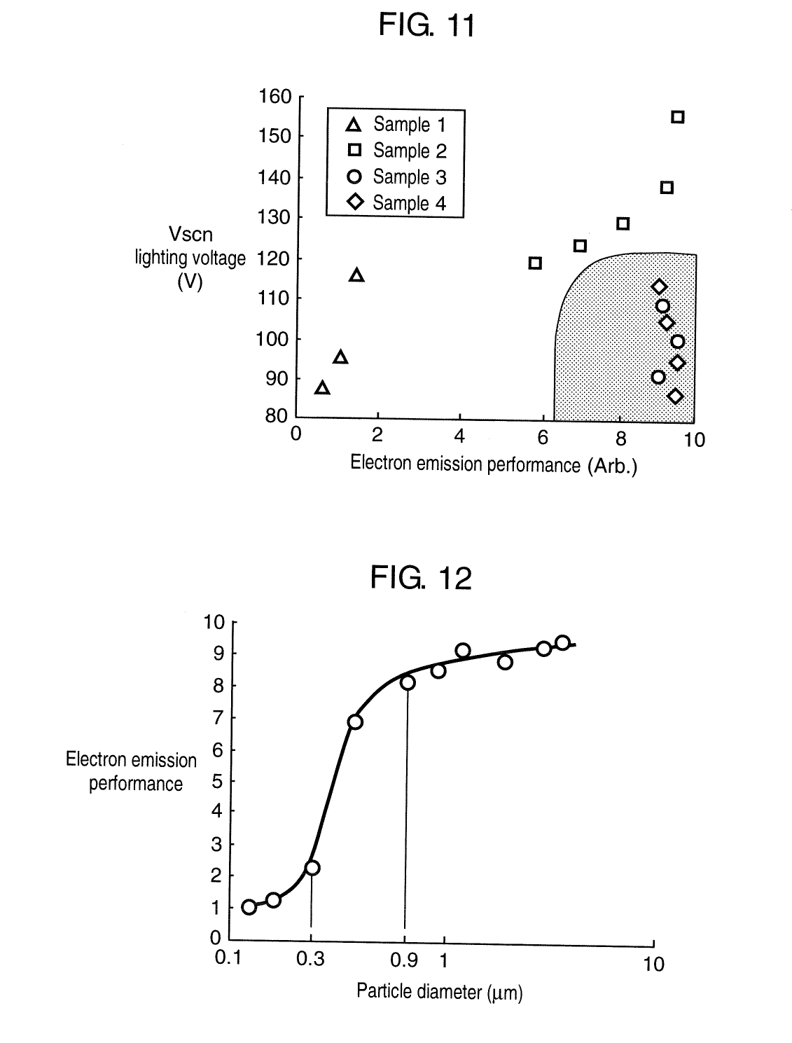

As can be seen from FIG. 11, the electron emission abilities of the protective layers of sample 3 and sample 4 have characteristics which are eight or more times greater than those of sample 1. According to the electric charge retention abilities of protective layers 9 of sample 3 and sample 4, the Vscn lighting voltage is 120 V or less. Therefore, the PDPs of sample 3 and sample 4 are more useful for the PDP in which the scan line number increases due to an increase in definition, and a cell size is small. That is, according to the PDPs of sample 3 and sample 4, the electron emission ability and the electric charge retention ability are both satisfied, so that a preferable image display can be provided at a lower voltage.

### 5-4. Evaluation 4

Next, the particle diameter of aggregated particle 92 will be described in detail. In addition, an average particle diameter of aggregated particle 92 is measured by observing aggregated particles 92 with a SEM.

As shown in FIG. 12, when the average particle diameter is as small as about 0.3 μM, the electron emission performance is low, but when it is 0.9 μm or more, high electron emission performance can be obtained.

In order to increase the electron emission number in the discharge cell, it is preferable to increase the crystal particle number per unit area on protective layer 9.

According to an experiment performed by the inventors, when crystal particles 92a and 92b exist in a part corresponding to a top of barrier rib 14 which is closely in contact with protective layer 9, the top of barrier rib 14 could be damaged. In this case, it has been found that when the material of damaged barrier rib 14 is put on the phosphor, a phenomenon that the corresponding cell is not correctly turned on or off is generated. The barrier rib is not likely to be damaged as long as the aggregated particles do not exist in the part corresponding to the top of the barrier rib. That is, an increase in number of aggregated particles 92 arranged in the disperse manner causes an increase in possibility of damaging barrier rib 14. In this point of view, when the average particle diameter increases to about 2.5 μm, the possibility of damaging the barrier rib abruptly becomes high. Meanwhile, when the average particle diameter is smaller than 2.5 μm, the possibility of damaging the barrier rib can be relatively suppressed to be small.

As described above, according to PDP 1 having protective layer 9 in this exemplary embodiment, the electron emission ability is eight or more, and as the electric charge retention ability, the Vscn lighting voltage is 120 V or less.

### 6. Wrap-Up

The method for producing PDP 1 disclosed in the present exemplary embodiment includes the following steps. By introducing a gas containing a reducing organic gas into a discharge space, protective layer 9 is exposed to the reducing organic gas. Then, the reducing organic gas is exhausted from the discharge space. Then, a discharge gas is enclosed to the discharge space.

Protective layer 9 exposed to the reducing organic gas has generation of oxygen deficiency. It is considered that the generation of oxygen deficiency makes the secondary electron emission capability of the protective layer high. Therefore, PDP 1 produced by the production method according to the present exemplary embodiment makes it possible to reduce a sustain voltage.

Moreover, the reducing organic gas is preferably a hydrocarbon-based gas without containing oxygen. This is because the reducing capability is improved by the fact that no oxygen is contained.

Furthermore, the reducing organic gas is preferably at least one gas selected from acetylene, ethylene, methylacetylene, propadiene, propylene, cyclopropane, propane and butane. This is because those reducing organic gases are easily handled in the production steps. This is also because those reducing organic gases are easily decomposed.

In addition, the present exemplary embodiment has exemplified a production method in which, after the discharge space has been exhausted, a gas containing a reducing organic gas is introduced into the discharge space. However, by continuously supplying the gas containing a reducing gas into the discharge space without exhausting the discharge space, the gas containing a reducing organic gas may also be introduced into the discharge space.

When protective layer 9 has, on base film 91, crystal particles 92a of the metal oxide or aggregated particles 92 each composed of aggregated crystal particles 92a of the metal oxide, the high electric charge retention ability and the high electron emission ability are provided. Therefore, as the whole of PDP 1, the high-speed driving can be implemented at the low voltage even in the case of the high-definition PDP. In addition, high-quality image display performance can be provided without generating a lighting defect.

In addition, this exemplary embodiment illustrates MgO as the crystal particles of the metal oxide. However, even when as another single-crystal particles, the crystal particles of the metal oxide of Sr, Ca, Ba or Al having high electron emission performance similar to MgO are used, the same effect can be provided. Thus, the crystal particle of the metal oxide is not limited to MgO.

### INDUSTRIAL APPLICABILITY

As described above, the technique disclosed in this exemplary embodiment is useful in providing a PDP in which high-definition and high-brightness display performance are implemented and power consumption is low.

### REFERENCE MARKS IN THE DRAWINGS

1 PDP
2 Front plate
3 Front glass substrate
4 Scan electrode
4a, 5a Transparent electrode
4b, 5b Metal bus electrode
5 Sustain electrode
6 Display electrode
7 Black stripe
8 Dielectric layer
9 Protective layer
10 Rear plate
11 Rear glass substrate
12 Data electrode
13 Insulating layer
14 Barrier rib
15 Phosphor layer
16 Discharge space
81 First dielectric layer
82 Second dielectric layer
91 Base film
92 Aggregated particles
92a Crystal particles

1. A method for manufacturing a plasma display panel having a discharge space, and a protective layer confronting the discharge space, wherein
the protective layer contains at least a first metal oxide and a second metal oxide, and has at least one peak in an X-ray diffraction analysis,
the peak exists between a first peak of the first metal oxide in the X-ray diffraction analysis, and a second peak of the second metal oxide in the X-ray analysis,
the first peak and the second peak show the same surface orientation as a surface orientation of the peak,
the first metal oxide and the second metal oxide are two kinds selected from a group consisting of a magnesium oxide, calcium oxide, strontium oxide, and barium oxide,
the method comprising:
exposing the protective layer to the reducing organic gas by introducing a gas containing a reducing organic gas into the discharge space;
exhausting the reducing organic gas from the discharge space; and
enclosing a discharge gas to the discharge space.

2. The method for manufacturing the plasma display panel according to claim 1, wherein
the plasma display panel comprises a front plate and a rear plate,
before introducing the gas containing the reducing organic gas into the discharge space, sealing the front plate and the rear plate together at peripheries with the discharge space kept at a positive pressure.

3. The method for manufacturing the plasma display panel according to claim 2, wherein
before introducing the gas containing the reducing organic gas into the discharge space, sealing the front plate and the rear plate together at peripheries with the discharge space kept at a positive pressure by supplying an inert gas to the discharge space.

4. The method for manufacturing the plasma display panel according to claim 2, wherein
before introducing the gas containing the reducing organic gas into the discharge space, sealing the front plate and the rear plate together at peripheries with the discharge space kept at a positive pressure by supplying dried air to the discharge space.

5. The method for manufacturing the plasma display panel according to claim 1, wherein
the reducing organic gas is a hydrocarbon series gas containing no oxygen.

6. The method for manufacturing the plasma display panel according to claim 5, wherein
the reducing organic gas is at least one kind selected from acetylene, ethylene, methyl acetylene, propadiene, propylene, cyclopropane, propane, and butane.

7. The method for manufacturing the plasma display panel according to claim 1, wherein
the protective layer further includes aggregated particles each obtained by aggregating a plurality of crystal particles of magnesium oxide, and the aggregated particles are dispersed entirely.
